(19) United States
(12) Patent Application Publication
(10) Pub. No.: US 2005/0013656 A1
(43) Pub. Date: Jan. 20, 2005

(54) Double universal joint

(76) Inventor: Ivan Nikolov Sotiror, Munchen (DE)

Correspondence Address: IVAN NIKOLOV SOTIROV, FRANKFURTER-RING 128, 80807 MUNCHEN, DE

(21) Appl. No.: 10/816,858

(22) Filed: Apr. 5, 2004

(30) Foreign Application Priority Data
Apr. 4, 2003 (BG) 107704

(51) Int. Cl. F16D 3/00

(52) U.S. Cl. 403/57

(57) ABSTRACT

In a double universal joint each of the two pivot-crosses has two swingers rotatably mounted on each of the two swinger-pivots located opposite to each other. The two swinger-pivots of the one-pivot-cross are located parallel to the two swinger-pivots of the other-pivot-cross. One swinger of the one-pivot-cross is coupled with opposite swinger of the other-pivot-cross and, the other swinger of the one-pivot-cross is coupled with the other opposite swinger of the other-pivot-cross, for symmetrically opposite swinging of each two coupled with each other swingers. The two swingers of each pivot-cross are coupled with the respective adjacent shaft-ends rotating at same direction when the adjacent shafts turn about the swinger-pivots and, at two opposite directions when the adjacent shafts turn about the cross-pivots, located perpendicularly to the swinger-pivots.

Double universal joint for transmitting uniform rotary motion from an input end-shaft to an output end-shaft having shaft axes intersecting with each other at a variable angle.

To achieve uniformity of the transmitted motion, in the prior art the double universal joints have a central tooth attached at the input end-shaft couppled with a boring on the output end-shaft. The couppling takes place at the center of rotation having limited high stressed contact surfaces. On the other hand, the oil material follows the centrifugal power toward the outside areas, leaving the center at the beguining of rotation.

It is an object of the invention to create unlimited contact surfaces for low stressed areas and to locate said areas at a distance to the axes of rotations.

According to the invention
two input teeth-wheels are rotatably mounted at one end of a middle-shaft about a cross-pivot-axis, and two output-wheels are mounted at the other end of the same middle-shaft about the other cross-pivot axis,
bevel teeth are mounted on each teeth-wheel. Bevel teeth are mounted on each end-shaft, couppled with the respective two bevel teeth-wheels on the respective middle-shaft end, for turning of each two input- and each output teeth-wheel at same direction about the respective input- and output middle cross-axis when the output end-shaft is turning about the respective input- and output middle cross-axis, and for turning of the same teeth-wheels at two opposite directions when the respective end-shaft is turning about the respective end cross-axis.

Parallel teeth are mounted on each teeth-wheel for couppling of each two wheels located at two difference middle-shaft ends for symmetrically transmitting of each input end-shaft direction to the output end-shaft direction for transmitting of uniform motion.

After the invention to contact surfaces are unlimited and low stressed areas and located at a distance to the axes of rotations beeing able to keep the oil on the contact surfaces.

The following description of a prefered embodiment will show the principle of the invention.

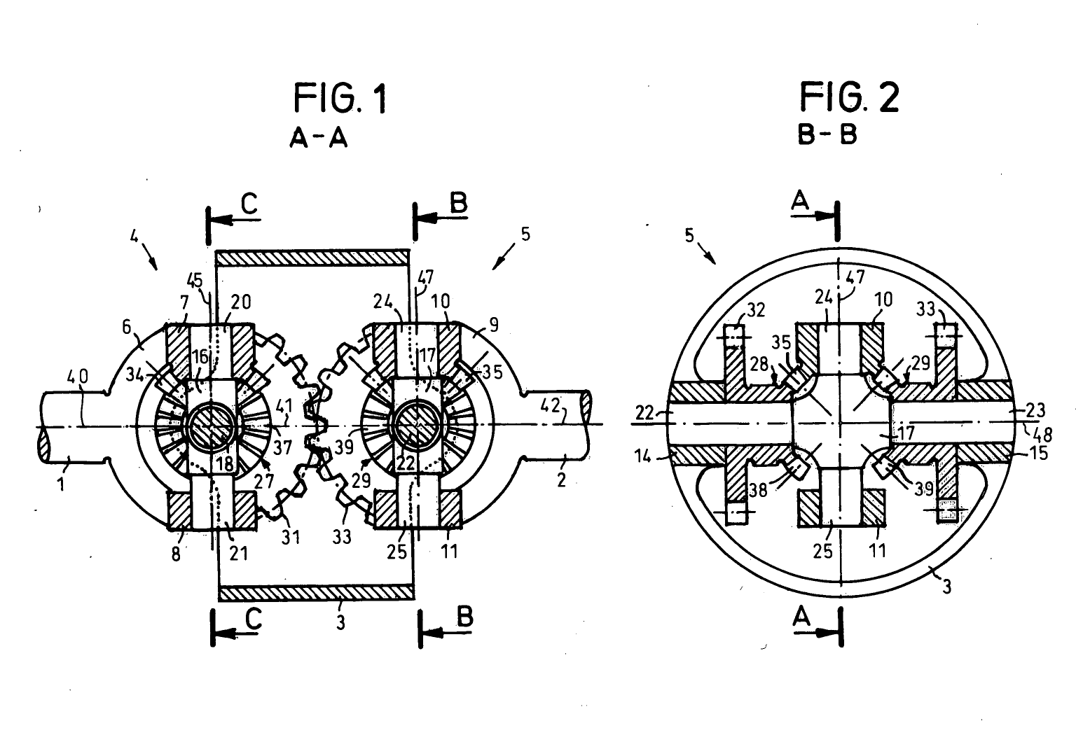

FIG. 1 is a longitudinal-section according to FIG. 2,

FIG. 2 is a cross-section of the outpu area, according to FIG. 1,

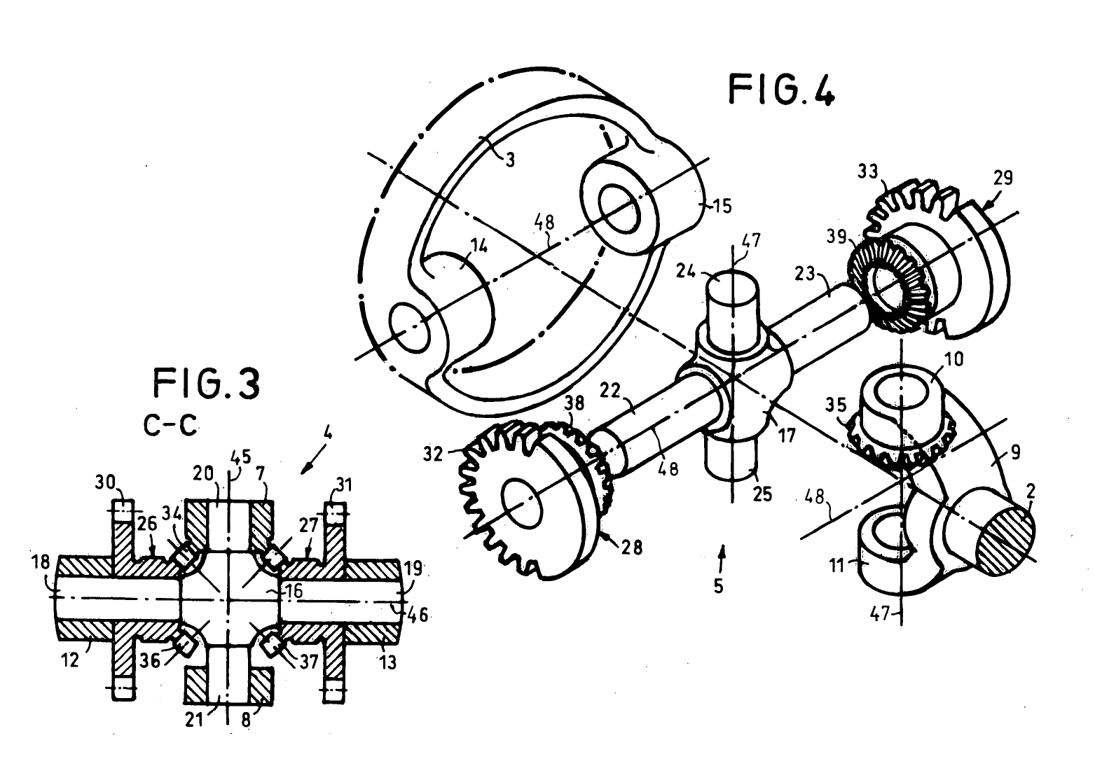

FIG. 3 is a cross-section of the input area, according to FIG. 1

FIG. 4 is a perspective picture of a part of the invention about the output area.

The double universal joint has an input end-shaft 1 transmitting non uniform motion to the middle-shaft 3 and uniform motion to the output end-shaft 2. The two ends of the middle shaft 3 are provided with sleeves 12, 13, 14, 15 having an input middle cross-axis 46 and an output middle cross-axis 48.

Input end-shaft 1 has a fork 6 with two sleeves 7, 8 and output end-shaft 2 has a fork 9 with two sleeves 10, 11. The two sleeves 7, 8 have a common end cross-axis 45 and the two sleeves 10, 11 have a common end cross-axis 47. An input pivot-cross 16 and an output pivot-cross 17 interconnect the three shafts 1, 2, 3 with each other. The input pivot-cross 16 has pivots 18, 19 with a middle cross-axis 46 rotatably mounted in the two sleeves 12, 13 of the one end of the middle shaft 3 and pivots 20, 21 with end cross-axis 45 are rotatably mounted in the two sleeves 7, 8 of the fork 6 of the input end-shaft 1.

The output pivot-cross 17 has pivots 22, 23 with middle cross-axis 48 rotatably mounted in the two sleeves 14, 15 of the other end of the middle shaft 3 and pivots 24, 25 with end-cross-axis 47 rotatably mounted in the two sleeves 10, 11 of the fork 9 of the output end-shaft 2.

According to the invention, the sleeves 7, 10 are provided with bevel-teeth 34, 35 for couppling with bevel-teeth 36, 37 and 38, 39.

Two input swingers 26, 28 provided with parallel teeth 30, 31 for couppling with each other are rotatably mounted on the pivots 18, 19 with middle cross-axis 46 and two output swingers 28, 29 provided with teeth 32, 33 for couppling with each other are rotatably mounted on the pivots 22, 23 with middle cross-axis 48.

All swingers 26, 27, 28, 29 have in addition bevel teeth 36, 37, 38, 39 for couppling with end-shaft sleeves 7, 10 for turning of each two input swingers 26, 27 and each two output swingers 28, 29 at same direction about the respective input and output middle cross-axis 46 and 48 when the input and output end-shaft 1, 2 are turning about the respective input and output middle cross-axes 46, 48 and for turning the two input and output swingers 26, 27 and 28, 29 at two opposite directions about the respective input and output middle cross-axis 46, 48 when the input and output end-shaft 1, 2 are turning about the respective end cross-axes 45, 47. The teeth coupplings of each input swinger 26, 27 with the respective output swingers 28, 29 result to symmetrically transmitting of each input end-shaft direction to the output end-shaft direction for transmitting of uniform motion.

More embodiments are possible with combinations of different constructions without departing from the principle idea of the invention.

1. Double universal joint for transmitting uniform rotary motion from an input end-shaft to an output end-shaft having shaft axes intersecting with each other at a variable angle, comprising:
the two end-shafts,
the middle-shaft,
an input intermediate element being connected pivotally
with the one end of said middle-shaft having input middle cross-axis intersecting perpendicularly the middle-shaft axis and
with said input end-shaft having end cross-axis intersecting perpendicularly the input end-shaft axis,
an output intermediate element being connected pivotally
with the other end of said middle-shaft having output middle cross-axis intersecting perpendicularly the middle shaft axis and
with said output end-shaft having end cross-axis intersecting perpendicularly the output end-shaft axis, each two cross-axes intersecting perpendicularly with each other,
characterized with
two input-swingers, rotatably mounted at one end of said middle-shaft about said input middle cross-axis,
means for angle couppling of said two input swingers with the end of said input end-shafts, for turning of said two input-swingers at same direction about said input middle cross-axis when the input end-shaft is turning about said input middle cross-axis and for turning of said two input swingers at two opposite directions about said input middle cross-axis when the input end-shaft is turning about the respective end cross-axis,
two output-swingers, rotatably mounted at the other end of said middle-shaft about said output middle cross-axis,
means for angle coupling of said two output-swingers with the end of said output end-shaft, for turning of said two output-swingers at same direction about said output middle cross-axis when the output end-shaft is turning about said output middle cross-axis and for turning of said two output swingers at two opposite directions about said output middle cross-axis when the output end-shaft is turning about the respective end cross-axis,
means for parallel couppling of each input-swinger with the respective output-swinger located at the same side of the middle-shaft axis, for symmetrically transmitting of each input end-shaft direction to the output end-shaft direction for transmitting of uniform motion.

2. Double universal joint for transmitting uniform rotary motion from an input end-shaft (1) to an output end-shaft (2) having shaft axes (40, 42) intersecting with each other at a variable angle, comprising:
the two end-shafts (1, 2),
the middle-shaft (3),
an input pivot-cross being connected pivotally
with the one end of said middle-shaft (3) having input middle cross-axis (46) intersecting perpendicularly the middle-shaft axis (41) and
with said input end-shaft (1) having end cross-axis (45) intersecting perpendicularly the input end-shaft axis (40),
an output pivot-cross being connected pivotally
with the other end of said middle-shaft (3) having output middle cross-axis (48) intersecting perpendicularly the middle shaft axis (41) and
with said output end-shaft (2) having end cross-axis (47) intersecting perpendicularly the output end-shaft axis (42), each two cross-axes (45, 46 and 47, 48) intersecting perpendicularly with each other,
characterized with
two input-swingers (26, 27), rotatably mounted at one end of said middle-shaft (3) about said input middle cross-axis (46),
bevel teeth (36, 37) mounted on each of said two input swingers (26, 27) and bevel teeth (34) mounted on each input end-shafts (1) being couppled with the bevel teeth of each input-swinger (26, 27),
for turning of said two input-swingers (26, 27) at same direction about said input middle cross-axis (46) when the input end-shaft (1) is turning about said input middle cross-axis (46) and for turning of said two input swingers (26, 27) at two opposite directions about said input middle cross-axis (46) when the input end-shaft (1) is turning about the respective end cross-axis (46),
two output-swingers (28, 29), rotatably mounted at the other end of said middle-shaft (3) about said output middle cross-axis (48),
bevel teeth (38, 39) mounted on each of said two output-swingers (28, 29) and bevel teeth (35) mounted on each output end-shaft (2),
for turning of said two output-swingers (28, 29) at same direction about said output middle cross-axis (48) when the output end-shaft (2) is turning about said output middle cross-axis (48) and for turning of said two output swingers (28, 29) at two opposite directions about said output middle cross-axis (48) when the output end-shaft (2) is turning about the respective end cross-axis (48),
parallel teeth couppling (30, 31 and 32, 33) of each input-swinger (26, 27) with the respective output-swinger (28, 29) located at the same side of the middle-shaft axis (41) for symmetrically transmitting of each input end-shaft direction to the output end-shaft direction for transmitting of uniform motion.
